(19) United States
(12) Patent Application Publication
(10) Pub. No.: US 2002/0171925 A1
(43) Pub. Date: Nov. 21, 2002

(54) Inverted microscope

(75) Inventors: Masahito Tonooka, Hachioji-shi (JP); Kazuhiko Yamanouchi, Hachioji-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 10/114,584

(22) Filed: Apr. 2, 2002

(30) Foreign Application Priority Data
Apr. 4, 2001 (JP) 2001-105928

(51) Int. Cl. G02B 21/00

(52) U.S. Cl. 359/381; 359/368; 359/380; 359/384; 359/388

(57) ABSTRACT

An inverted microscope of the present invention comprising a microscope main body including a relay optical system which forms a primary intermediate image of a sample by a light from the sample irradiated with an irradiation light via an objective lens and an image forming lens, and which relays a light flux from the primary intermediate image, and a light path switch unit which is disposed in the microscope main body to be attachable/detachable, and which branches the light flux relayed by the relay optical system.

### CROSS-REFERENCE TO RELATED APPLICATIONS

This application is based upon and claims the benefit of priority from the prior Japanese Patent Application No. 2001-105928, filed Apr. 4, 2001, the entire contents of which are incorporated herein by reference.

### BACKGROUND OF THE INVENTION

1. Field of the Invention

The present invention relates to an inverted microscope in which a sample laid on a stage is enlarged by an objective lens right under the sample and observed.

2. Description of the Background Art

An inverted microscope has been broadly used in researches in respective fields for handing living cells, such as medicine and physiology, and industrial researches/examinations such as structure observation and defect/content detection of various metal materials.

In a known constitution of the inverted microscope, an observation light path obliquely turns upwards, that is, toward an observer. The observation light path strictly forms an angle parallel to an angle of the light path of an attached eyepiece, that is, an angle of 45° with respect to the light path of the objective lens. In general, this type of inverted microscope requires only one deflection of an observation light in order to obliquely guide the observation light path upwards. Therefore, a structure concerning the observation light path is simple, and cost reduction can be realized.

Moreover, examples of the inverted microscope in which the observation light path obliquely turns upwards include a microscope in which the observation light path forming the angle of 45° is split. In this inverted microscope, an imaging light path for an attachment camera can freely be inserted. As one example, Jpn. Pat. Appln. KOKAI Publication No. 3-172816 discloses a microscope in which a light path split member for splitting the observation light path, imaging light path, and attachment camera mounting portion are arranged in an observation tube.

FIG. 10 is a diagram showing a schematic configuration of the above-described inverted microscope. The microscope includes a main body 101 and observation tube 102. The main body 101 includes a vertical illuminator 103, a revolver 104, a plurality of condenser optical systems (objective lenses) 105, a half mirror 106, a stage 107, an image forming optical system 108, an observation light path 109, a reflective mirror 110, an observation tube mounting portion 111, and an afocal optical system 113. The vertical illuminator 103 guides a light flux from a light source apparatus (not shown). The plurality of condenser optical systems (objective lenses) 105 are held in the revolver 104 and selectively disposed in the light path. The half mirror 106 deflects the light flux from the vertical illuminator 103 in a direction of the condenser optical system 105. A sample (not shown) is laid on the stage 107. The image forming optical system 108 forms an image of the light flux directed downwards by the condenser optical system 105 positioned below the sample. The reflective mirror 110 deflects the light flux to the observation light path 109 which is obliquely directed upwards. The observation tube mounting portion 111 is positioned in a portion through which the observation light path 109 is passed, and is obliquely directed upwards. The afocal optical system 113 forms a primary intermediate image 112 which forms a conjugate image with respect to a sample surface after the image forming optical system 108, and forms the light flux from the primary intermediate image 112 into an afocal light flux.

The observation tube 102 includes a main body mounting portion 114, observation-side image forming optical system 115, light path split member 117, attachment mounting portion 118, and sleeve 119. The observation tube 102 is attached to the observation tube mounting portion 111 of the main body 101 by the main body mounting portion 114. The observation-side image forming optical system 115 is disposed on the observation light path 109, and the afocal light emitted from the main body 101 is formed into the image. The light path split member 117 is disposed after the observation-side image forming optical system 115, and splits an imaging light path 116 from the observation light path 109. An attachment for attaching a TV camera or the like on the side of the imaging light path 116 can be attached to the attachment mounting portion 118. An eyepiece 120 can be attached to the sleeve 119.

In the configuration, the imaging light path 116 is disposed in the observation tube 102, and the observation tube 102 is attached to the main body 101, so that the inverted microscope having the imaging light path 116 added thereto can easily be constructed.

Additionally, in the inverted microscope, the light path split member 117, imaging light path 116, and attachment mounting portion 118 have an integral structure in the observation tube 102. The light path split member 117 is disposed after the observation-side image forming optical system 115 in this structure. Therefore, the image forming optical system for forming the image on the TV camera or the like on the side of the imaging light path 116 can be disposed in common in the observation-side image forming optical system 115, but there is a problem as follows.

Since the imaging light path 116 is integrally formed with the observation tube 102, two types of observation tubes 102 in total have to be prepared for an observer requiring the imaging light path 116 and an observer requiring no path. Moreover, when the imaging light path is to be added to the microscope including the observation tube having no imaging light path attached thereto, the observation tube has to be replaced with the observation tube including the imaging light path. Furthermore, when applications such as a function of switching the light path, a function of varying the magnification of the imaging side image forming optical system, and a function adapted for a photographing apparatus are newly constructed, the observation tube including these new functions is constructed. In this case, in order to add new functions, the whole observation tube has to be upgraded.

In the above-described inverted microscope, a new observation tube has to be prepared in accordance with a use situation, and a cost disadvantageously increases.

### BRIEF SUMMARY OF THE INVENTION

An object of the present invention is to provide an inverted microscope in which a unit for switching a light path is attached to/detached from a main body, and thereby an imaging light path can easily be inserted/removed.

According to the present invention, there is provided an inverted microscope comprising: a microscope main body including a relay optical system which forms a primary intermediate image of a sample by a light from the sample irradiated with an irradiation light via an objective lens and an image forming lens, and which relays a light flux from the primary intermediate image, and a light path switch unit which is disposed in the microscope main body to be attachable/detachable, and which branches the light flux relayed by the relay optical system.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a diagram showing a schematic configuration of an inverted microscope according to a first embodiment of the present invention.

FIG. 2 is a diagram showing the schematic configuration of the inverted microscope according to the first embodiment of the present invention.

FIG. 3 is a diagram showing the schematic configuration of the inverted microscope according to a second embodiment of the present invention.

FIG. 4 is a diagram showing the schematic configuration of the inverted microscope according to the second embodiment of the present invention.

FIG. 5 is a diagram showing the schematic configuration of the inverted microscope according to a third embodiment of the present invention.

FIG. 6 is a diagram showing the schematic configuration of the inverted microscope according to a fourth embodiment of the present invention.

FIGS. 7A, 7B are diagrams showing the schematic configuration of the inverted microscope according to the fourth embodiment of the present invention.

FIG. 8 is a diagram showing the schematic configuration of the inverted microscope according to a fifth embodiment of the present invention.

FIG. 9 is a diagram showing the schematic configuration of the inverted microscope according to the fifth embodiment of the present invention.

FIG. 10 is a diagram showing the schematic configuration of the inverted microscope according to a conventional example.

### DETAILED DESCRIPTION OF THE INVENTION

Embodiments of the present invention will be described hereinafter with reference to the drawings.

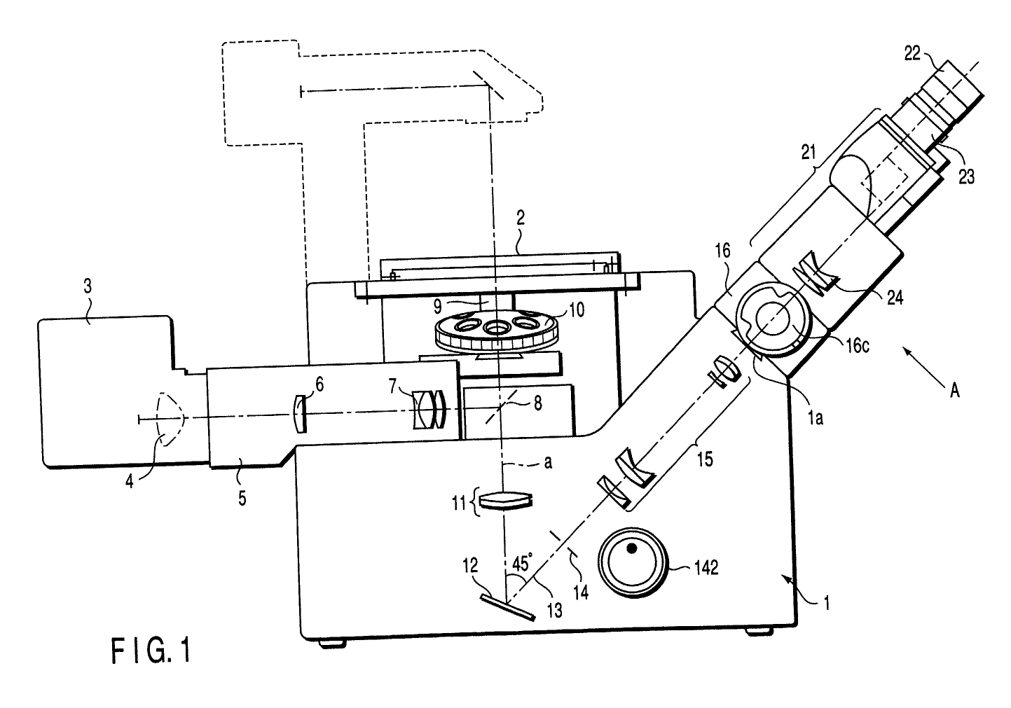

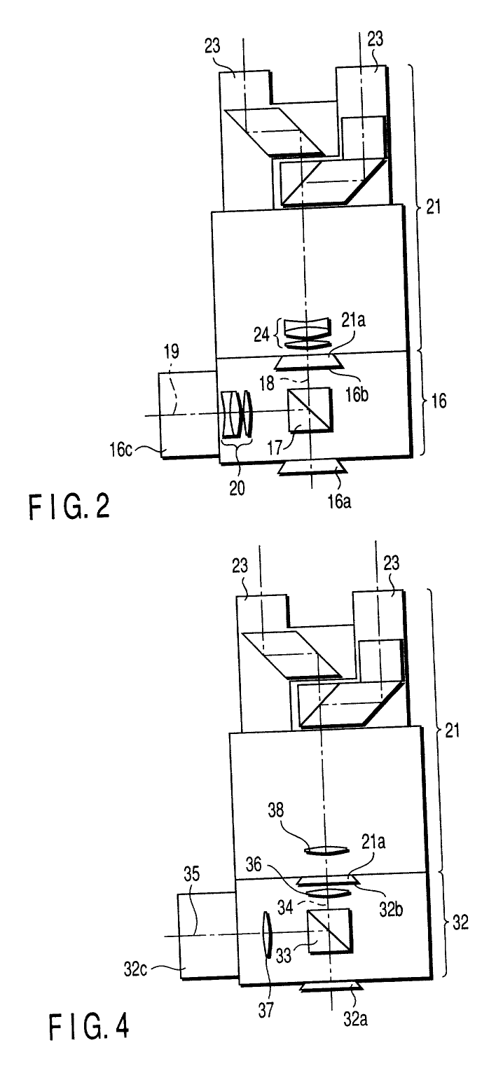

FIGS. 1, 2 are diagrams showing a schematic configuration of an inverted microscope according to a first embodiment of the present invention. FIG. 1 is a side view, and FIG. 2 is a front view (A arrow view) of an intermediate attachment unit and observation tube of FIG. 1 seen from the front lower side of the microscope.

In FIG. 1, a stage 2 on which a sample (not shown) is to be laid is disposed in a main body (microscope main body) 1. A light source apparatus 3 includes a halogen lamp, and the like. A light flux from the light source apparatus 3 is guided to a vertical illuminator 5 via a correcting lens 4, and is incident upon a half mirror 8 via relay lenses 6, 7. That is, the relay lenses 6, 7 of the vertical illuminator 5 relay the light condensed by the correcting lens 4.

The light flux reflected by the half mirror 8 is emitted to the sample on the stage 2 via an objective lens 9. A revolver 10 can hold a plurality of objective lenses 9, and selectively disposes one objective lens 9 on a light axis a. Additionally, FIG. 1 shows only one objective lens 9.

Moreover, the revolver 10 is moved in a vertical direction by operating a focusing handle 142 which is disposed on the side surface of the main body 1. That is, when the focusing handle 142 is operated, the sample laid on the stage 2 is focused with the objective lens 9.

The light from the sample, that is, the reflected light, is transmitted through the half mirror 8, and is incident upon an image forming optical system 11. The image forming optical system 11 forms an enlarged image of the sample together with the objective lens 9. The light flux of the enlarged image is incident upon a reflective mirror 12. The reflective mirror 12 is disposed in the lowermost end of the main body 1. The reflective mirror 12 obliquely reflects upwards (here, 45° with respect to the light axis a of the objective lens 9) the image forming light flux of the sample, vertically emitted downwards by the objective lens 9 and image forming optical system 11. Moreover, the reflective mirror 12 forms a primary intermediate image 14 on an observation light path 13 in which the image forming light flux is obliquely directed upwards.

The primary intermediate image 14 is incident upon an afocal optical system 15 as a relay optical system.

The afocal optical system 15 relays the light flux from the primary intermediate image 14 to an observation tube mounting portion 1a, and the light flux emitted from the observation tube mounting portion la is shaped into an afocal light flux. The observation tube mounting portion 1a is positioned in the front upper portion of the main body 1, and obliquely directed upwards (here, 45° with respect to the light axis a of the objective lens 9).

An intermediate attachment unit 16 is attached to the observation tube mounting portion (concave portion) 1a. As shown in FIG. 2, a main body mounting portion (convex portion) 16a and observation tube mounting portion (concave portion) 16b are disposed on opposite ends of the intermediate attachment unit 16, and an attachment mounting portion 16c is disposed on the side surface of the unit. The main body mounting portion 16a is attached to the observation tube mounting portion la of the main body 1. An observation tube 21 is attached to the observation tube mounting portion 16b. An attachment for attaching the imaging apparatuses such as a TV camera is attached to the attachment mounting portion 16c.

A light path split element 17 is disposed inside the intermediate attachment unit 16. The light path split element 17 branches the afocal light flux incident upon the side of the main body mounting portion 16a from the afocal optical system 15 into an observation light path 18 and imaging light path 19. The observation light path 18 is a light path having the same rectilinear propagation direction as that of the afocal light flux. The imaging light path 19 is a light path crossing at right angles to the observation light path 18.

The observation light path 18 passed through the light path split element 17 in the rectilinear propagation direction is derived toward the side of the observation tube 21 from the observation tube mounting portion 16b. The imaging light path 19 guided in a direction crossing at right angles to the observation light path 18 by the light path split element 17 is derived toward the side of the imaging apparatuses such as the TV camera from the attachment mounting portion 16c. An image forming optical system 20 is disposed before the attachment mounting portion 16c on the imaging light path 19. The image forming optical system 20 forms the afocal light branched by the light path split element 17 into the image on the imaging surface of the TV camera or the like. In the image forming optical system 20, a lens whose magnification is fixed, or a lens group such as a zoom optical system whose magnification can be varied is used.

The observation tube 21 is attached to the observation tube mounting portion 16b of the intermediate attachment unit 16. The observation tube 21 has sleeves 23, 23 onto which an eyepiece 22 is mounted. A main body mounting portion (convex portion) 21a is disposed in the observation tube 21. The main body mounting portion 21a is attached to the observation tube mounting portion 16b of the intermediate attachment unit 16 or the observation tube mounting portion 1a of the main body 1. Thereby, the observation tube 21 is attached to the intermediate attachment unit 16 or the main body 1. In FIGS. 1 and 2, the main body mounting portion 21a of the observation tube 21 is attached to the observation tube mounting portion 16b of the intermediate attachment unit 16.

Inside the observation tube 21, an image forming optical system 24 is disposed on the observation light path 18 introduced from the side of the intermediate attachment unit 16. The image forming optical system 24 forms the afocal light flux into an observation image by the eyepiece 22.

The intermediate attachment unit 16 configured as described above can be attached/detached between the main body 1 and the observation tube 21. When the intermediate attachment unit 16 is attached between the body and the tube, the light path split element 17 forms the observation light path 18 and imaging light path 19. When the observation light path 18 is formed, the sample can visually be observed by the eyepiece 22 via the observation tube 21. Moreover, when the imaging light path 19 is formed, the sample image can be photographed by the imaging apparatuses such as the TV camera.

Moreover, when the intermediate attachment unit 16 is not attached between the main body 1 and the observation tube 21, the observation tube 21 can directly be attached to the observation tube mounting portion 1a of the main body 1. Thereby, only the visual observation of the sample by the eyepiece 22 can be performed. The light flux emitted from the main body 1 is the afocal light flux. Therefore, even when the intermediate attachment unit 16 is inserted or not, the sample image does not seem to be different, and the sample can constantly steadily be observed.

According to the first embodiment, when the intermediate attachment unit 16 is inserted between the main body 1 and the observation tube 21, the imaging light path 19 can easily be formed. Additionally, the intermediate attachment unit 16 is separate from the observation tube 21. Therefore, when the intermediate attachment unit 16 is simply attached/detached, the imaging light path 19 can easily be inserted/removed without changing the whole observation tube 21.

Moreover, the optical systems such as the zoom lens whose magnification can be varied can be used as the image forming optical system 20 disposed before the attachment mounting portion 16c on the imaging light path 19. Thereby, the magnification on the side of the imaging light path 19 can optionally be varied, and set in such a manner that the magnification of the image on the imaging light path 19 side differs from that on the observation light path 18 side.

Additionally, in the above-described embodiment, the sample image is the reflected light from the sample, but is not limited to the embodiment. For example, when a light source unit for transmission observation is disposed as shown by a broken line in FIG. 1, a transmitted light from the sample can also be observed. Moreover, when a fluorescence of the sample is observed, design changes such as replacement of the light source apparatus 3 of the halogen lamp in FIG. 1 with a light source for exciting the fluorescence are performed. Then, the fluorescence observation can also be realized.

Moreover, in the above-described embodiment, the TV camera is an example of the imaging apparatus, but the apparatus is not limited to the embodiment. Various cameras such as a silver salt camera and digital camera can be attached.

Furthermore, in the above-described embodiment, the light path split element is disposed in the intermediate attachment unit, but the configuration is not limited to the embodiment. For example, when the light path split element is replaced with a light path switch element such as a total reflection mirror, and the mirror is constituted to be insertable/removable with respect to the light path, the light from the sample which is 100% visible by the eyepiece can be guided to the imaging apparatus as much as 100% without being split.

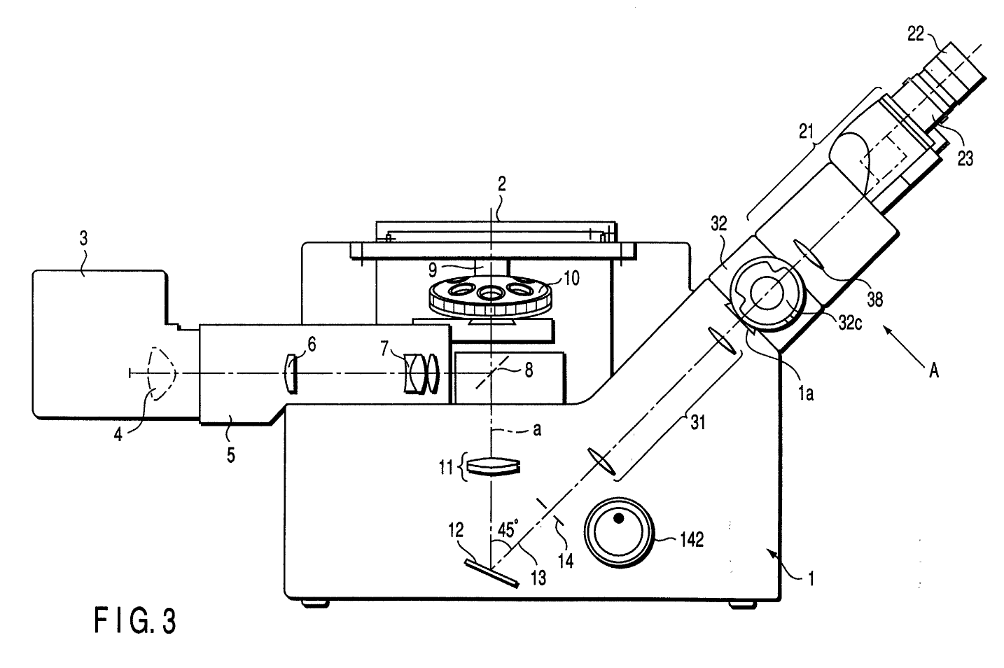

FIGS. 3, 4 are diagrams showing the schematic configuration of the inverted microscope according to a second embodiment of the present invention. FIG. 3 is a side view, and FIG. 4 is a front view (A arrow view) of the intermediate attachment unit and observation tube of FIG. 3 seen from the front lower side of the microscope. Additionally, in FIGS. 3, 4, the same components as those of FIGS. 1, 2 are denoted with the same reference numerals.

In FIG. 3, the primary intermediate image 14 on the observation light path 13 in the main body 1 is incident upon a converging optical system 31 as the relay optical system. The converging optical system 31 relays the light flux from the primary intermediate image 14 to the observation tube mounting portion 1a, and the light flux emitted from the observation tube mounting portion la is shaped into a converged light. The observation tube mounting portion 1a is positioned in the front upper portion of the main body 1, and obliquely directed upwards (here, 45° with respect to the light axis a of the objective lens 9).

An intermediate attachment unit 32 is attached to the observation tube mounting portion (concave portion) 1a. As shown in FIG. 4, a main body mounting portion (convex portion) 32a and observation tube mounting portion (concave portion) 32b are disposed on the opposite ends of the intermediate attachment unit 32, and an attachment mounting portion 32cis disposed on the side surface of the unit. The main body mounting portion 32a is attached to the observation tube mounting portion 1a of the main body 1. The observation tube 21 is attached to the observation tube mounting portion 32b. The attachment for attaching the imaging apparatuses such as the TV camera is attached to the attachment mounting portion 32c.

A light path split element 33 is disposed inside the intermediate attachment unit 32. The light path split element 33 branches the converged light incident upon the side of the main body mounting portion 32a from the converging optical system 31 into an observation light path 34 and imaging light path 35. The observation light path 34 is a light path having the same rectilinear propagation direction as that of the converged light, and the imaging light path 35 is a light path crossing at right angles to the observation light path 34.

The observation light path 34 passed through the light path split element 33 in the rectilinear propagation direction is derived toward the side of the observation tube 21 from the observation tube mounting portion 32b. The imaging light path 35 guided in the direction crossing at right angles to the observation light path 34 by the light path split element 33 is derived toward the side of the imaging apparatuses such as the TV camera from the attachment mounting portion 32c. A correction optical system 36 is disposed before the observation tube mounting portion 32b on the observation light path 34. The correction optical system 36 corrects a light path length changed by inserting the intermediate attachment unit 32. An image forming optical system 37 is disposed before the attachment mounting portion 32c on the imaging light path 35. The image forming optical system 37 forms the converged light branched by the light path split element 33 into the image on the imaging surface of the TV camera or the like.

The observation tube 21 is attached to the observation tube mounting portion 32b of the intermediate attachment unit 32. Inside the observation tube 21, an image forming optical system 38 is disposed on the observation light path 34 introduced from the side of the intermediate attachment unit 32. The image forming optical system 38 forms the converged light into the observation image by the eyepiece 22.

The intermediate attachment unit 32 configured as described above can be attached/detached between the main body 1 and the observation tube 21. When the intermediate attachment unit 32 is attached between the body and the tube, the light path split element 33 forms the observation light path 34 and imaging light path 35. When the observation light path 34 is formed, the sample can visually be observed by the eyepiece 22 via the observation tube 21. Moreover, when the imaging light path 35 is formed, the sample image can be photographed by the imaging apparatuses such as the TV camera.

Moreover, when the intermediate attachment unit 32 is not attached between the main body 1 and the observation tube 21, the observation tube 21 can directly be attached to the observation tube mounting portion 1a of the main body 1. Thereby, only the visual observation of the sample by the eyepiece 22 can be performed.

According to the second embodiment, when the intermediate attachment unit 32 is inserted between the main body 1 and the observation tube 21, the imaging light path 35 can easily be formed. Additionally, the intermediate attachment unit 32 is separate from the observation tube 21. Therefore, when the intermediate attachment unit 32 is simply attached/detached, the imaging light path 35 can easily be inserted/removed without changing the whole observation tube 21.

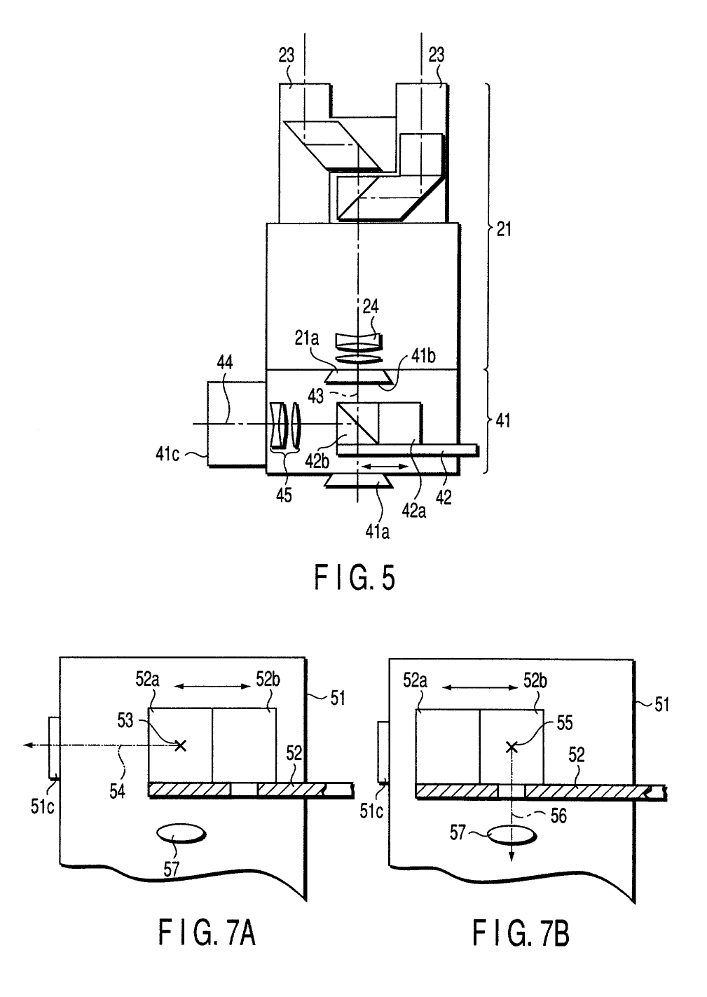

FIG. 5 is a diagram showing the schematic configuration of the inverted microscope according to a third embodiment of the present invention, and is a front view of the intermediate attachment unit and observation tube seen from the front lower side of the microscope. In FIG. 5, the same part as that of FIG. 2 is denoted with the same reference numerals. Additionally, the whole configuration of the inverted microscope is similar to that of FIG. 1.

In FIG. 5, an intermediate attachment unit 41 is attached to the observation tube mounting portion (concave portion) la of the main body 1. A main body mounting portion (convex portion) 41a and observation tube mounting portion (concave portion) 41b are disposed on opposite ends of the intermediate attachment unit 41, and an attachment mounting portion 41c is disposed on the side surface of the unit. The main body mounting portion 41a is attached to the observation tube mounting portion 1a of the main body 1. The observation tube 21 is attached to the observation tube mounting portion 41b. The attachment for attaching the imaging apparatuses such as the TV camera is attached to the attachment mounting portion 41c.

A light path switch mechanism 42 is disposed in the intermediate attachment unit 41. In the light path switch mechanism 42, a transmission optical element 42a and light path split element 42b are arranged in the direction of an imaging light path 44. The light path switch mechanism 42 has a function of sliding the transmission optical element 42a and light path split element 42b in the direction of the imaging light path 44. The transmission optical element 42a guides the afocal light flux incident upon the side of the main body mounting portion 41a from the afocal optical system 15 into the observation light path 43. The observation light path 43 is a light path having the same rectilinear propagation direction as that of the afocal light flux. The light path split element 42b branches the afocal light flux from the afocal optical system 15 into the observation light path 43 and imaging light path 44. That is, the light path split element 42b guides a part of the afocal light flux from the afocal optical system 15 into the imaging light path 44. The imaging light path 44 is a light path crossing at right angles to the observation light path 43. The light path switch mechanism 42 slides the transmission optical element 42a and light path split element 42b in the direction of the imaging light path 44, and selectively disposes the elements on the observation light path 43. In FIG. 5, the light path split element 42b is disposed on the observation light path 43.

When the transmission optical element 42a is disposed on the observation light path 43, the observation light path 43 guided in the rectilinear propagation direction is derived toward the side of the observation tube 21 from the observation tube mounting portion 41b. Moreover, when the light path split element 42b is disposed on the observation light path 43, the observation light path 43 transmitted in the rectilinear propagation direction is derived toward the side of the observation tube 21 from the observation tube mounting portion 41b. The imaging light path 44 guided in the direction crossing at right angles to the observation light path 43 is derived toward the side of the imaging apparatuses such as the TV camera from the attachment mounting portion 41c. An image forming optical system 45 is disposed before the attachment mounting portion 41c on the imaging light path 44. The image forming optical system 45 forms the afocal light branched by the light path split element 42b into the image on the imaging surface of the TV camera or the like.

According to the third embodiment, the intermediate attachment unit 41 is used instead of the intermediate attachment unit 16 shown in FIG. 1, and can be inserted/attached between the main body 1 and the observation tube 21. Moreover, when the light path split element 42b is switched onto the light path, the imaging light path 44 can easily be formed. Furthermore, when the transmission optical element 42a and light path split element 42b are selectively disposed on the light path, the observation light path 43 and imaging light path 44 can easily be switched.

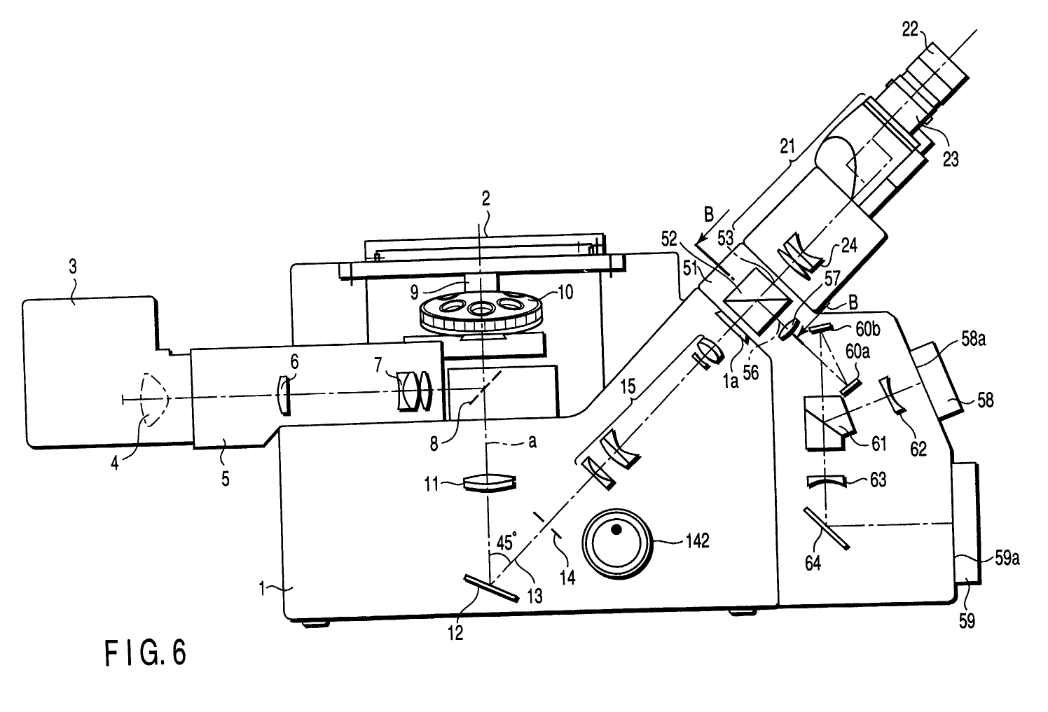

FIGS. 6, 7A, 7B are diagrams showing the schematic configuration of the inverted microscope according to a fourth embodiment of the present invention. FIG. 6 is a side view, and FIGS. 7A, 7B are partial front sectional views of the intermediate attachment unit of FIG. 6 seen from the rear lower side (B-B sectional view) of the microscope. Additionally, in FIG. 6, the same components as those of FIG. 1 are denoted with the same reference numerals.

In FIG. 6, the primary intermediate image 14 on the observation light path 13 in the main body 1 is relayed by the afocal optical system 15, and emitted from the observation tube mounting portion 1a. An intermediate attachment unit 51 is attached to the observation tube mounting portion 1a. Since the intermediate attachment unit 16 shown in FIG. 1 can be attached to the observation tube mounting portion 1a, the intermediate attachment units 51 and 16 can freely be replaced with each other with respect to the main body 1.

A main body mounting portion (convex portion) and observation tube mounting portion (concave portion) (not shown) are disposed on the opposite ends of the intermediate attachment unit 51, and an attachment mounting portion 51c is disposed on the side surface of the unit as shown in FIGS. 7A, 7B. The main body mounting portion is attached to the observation tube mounting portion la of the main body 1. The observation tube 21 is attached to the observation tube mounting portion. The attachment for attaching the imaging apparatuses such as the TV camera is attached to the attachment mounting portion 51c.

A light path switch mechanism 52 is disposed in the intermediate attachment unit 51. In the light path switch mechanism 52, a first light path branch element 52a and second light path branch element 52b are arranged in the direction of an imaging light path 54. The light path switch mechanism 52 has a function of sliding the first and second light path branch elements 52a and 52b in the direction of the imaging light path 54.

The first light path branch element 52a branches the afocal light flux incident upon the side of the main body mounting portion from the afocal optical system 15 into an observation light path 53 and the imaging light path 54 as shown in FIG. 7A. The observation light path 53 is a light path having the same rectilinear propagation direction as that of the afocal light flux which is obliquely directed upwards from the lower part of the main body 1. The imaging light path 54 is a light path crossing at right angles to the observation light path 53, and guides a part of the afocal light flux leftwards toward the side of the attachment mounting portion 51c. The second light path branch element 52b branches the afocal light flux incident upon the side of the main body mounting portion from the afocal optical system 15 into an observation light path 55 and imaging light path 56 as shown in FIG. 7B. The observation light path 55 is a light path having the same rectilinear propagation direction as that of the afocal light flux which is obliquely directed upwards from the lower part of the main body 1. The imaging light path 56 is a light path crossing at right angles to the observation light path 55, and guides a part of the afocal light flux downwards toward the side of a projection optical system 57.

These first and second light path branch elements 52a and 52b are moved by the light path switch mechanism 52 in an arrow direction shown in FIGS. 7A, 7B, and can selectively be switched onto the light path. Additionally, FIG. 7A shows that the first light path branch element 52a is switched onto the light path, and FIG. 7B shows that the second light path branch element 52b is switched onto the light path.

The projection optical system 57 is disposed on the imaging light path 56. The projection optical system 57 forms the image of the light flux relayed through the afocal optical system 15 on a 35 mm sized camera 58 (camera using a 35 mm sized silver salt film) and a large-sized camera 59 (camera with a size exceeding 35 mm). Additionally, a 35 mm sized camera mounting portion 58a and large-sized camera mounting portion 59a are disposed on the microscope front surface side of the intermediate attachment unit 51. The 35 mm sized camera 58 and large-sized camera 59 are attached to the 35 mm sized camera mounting portion 58a and large-sized camera mounting portion 59a.

In the intermediate attachment unit 51, the light flux transmitted through the projection optical system 57 is reflected twice by mirrors 60a, 60b, and incident upon a light path split prism 61. The light flux is branched into two light paths by the light path split prism 61. The light flux of one light path is formed into the image on the 35 mm sized camera 58 with desired projecting magnification by a photographing lens for the 35 mm sized camera 62. Moreover, the light flux of the other light path is formed into the image on the large-sized camera with desired projecting magnification by a photographing lens for the large-sized camera 63 via the reflective mirror 64.

In the above-described configuration, when the light path switch mechanism 52 switches the first light path branch element 52a onto the light path, the action/effect is obtained similarly as the first embodiment. On the other hand, when the light path switch mechanism 52 switches the second light path branch element 52b onto the light path, the afocal light flux from the afocal optical system 15 is branched into the observation light path 55 having the rectilinear propagation direction and the imaging light path 56 having the direction crossing at right angles to the observation light path 55. The light flux guided along the imaging light path 56 is transmitted through the projection optical system 57, reflected twice by the mirrors 60a, 60b, and branched into two light paths by the light path split prism 61. Moreover, one light flux is formed into the image on the 35 mm sized camera 58 via the photographing lens for the 35 mm sized camera 62, and the other light flux is formed into the image on the large-sized camera 59 via the photographing lens for the large-sized camera 63 and reflective mirror 64. Thereby, the respective sample images can be photographed by the 35 mm sized camera 58 and large-sized camera 59.

The example in which both the 35 mm sized camera 58 and the large-sized camera 59 are mounted on the intermediate attachment unit 51. However, only one of the 35 mm sized camera 58 and large-sized camera 59 may be attached, and the photographing can be performed only with the attached camera. Moreover, as described above, both the 35 mm sized camera 58 and the large-sized camera 59 may be mounted on the intermediate attachment unit 51, so that only one camera can photograph the image by switching between the optical element transmitting the light flux to only the side of the large-sized camera 59 and the optical element reflecting the light flux to only the side of the 35 mm sized camera 58. Additionally, instead of the 35 mm sized camera and large-sized camera, the TV camera or a digital camera may be attached and constituted to perform the photographing.

According to the fourth embodiment, at least one of the 35 mm sized camera 58 and large-sized camera 59 can be mounted on the intermediate attachment unit 51, and the intermediate observation tube unit 51 is simply inserted between the main body 1 and the observation tube 21, so that the photography can easily be performed by the 35 mm sized camera 58 and large-sized camera 59.

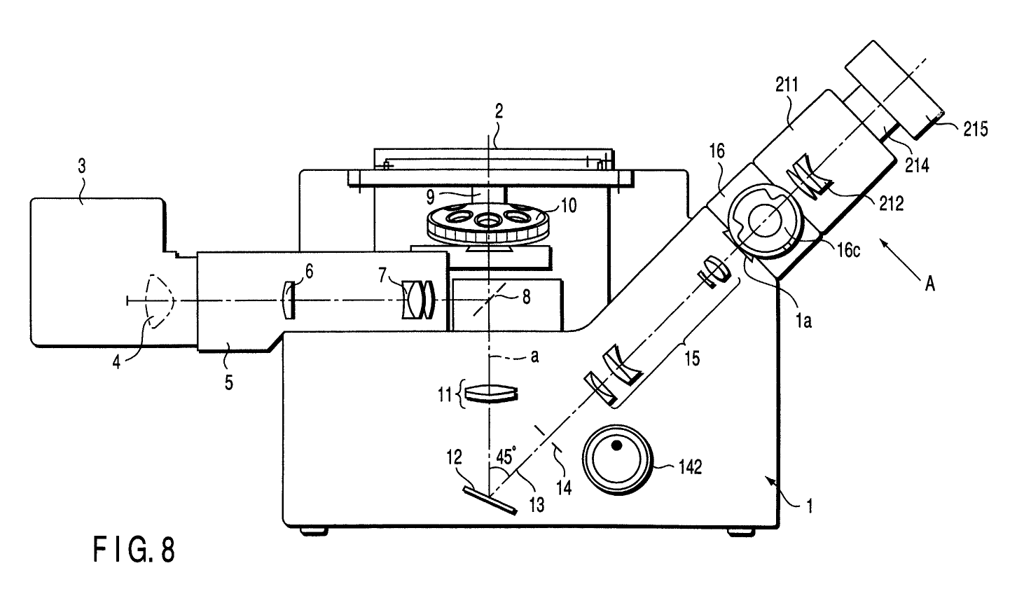

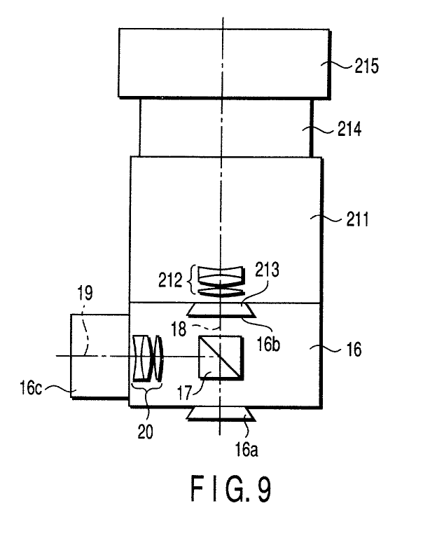

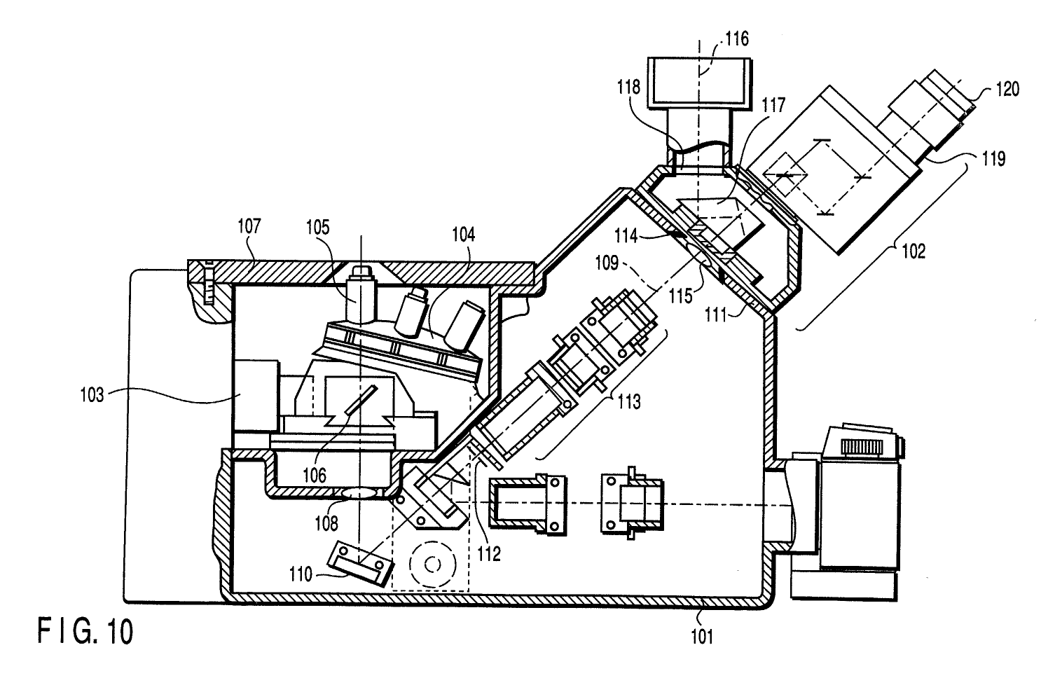

FIGS. 8, 9 are diagrams showing the schematic configuration of the inverted microscope according to a fifth embodiment of the present invention. FIG. 8 is a side view, and FIG. 9 is a front view (A arrow view) of the intermediate attachment unit and imaging unit of FIG. 8 seen from the front lower side of the microscope. Additionally, in FIGS. 8, 9, the same part as that of FIGS. 1, 2 is denoted with the same reference numerals.

In the fifth embodiment, an imaging unit is attached instead of the observation tube in the microscope shown in the first embodiment, so that a CCD camera (digital camera), TV camera, photographing apparatus (silver salt camera), and the like can be mounted instead of the eyepiece.

The inverted microscope shown in FIGS. 8, 9 includes the main body 1, intermediate attachment unit 16, and imaging unit 211. The imaging unit 211 is attached to the observation tube mounting portion 16b of the intermediate attachment unit 16. A main body mounting portion (convex portion) 213 is disposed in the imaging unit 211. The main body mounting portion 213 is mounted onto the observation tube mounting portion 16b of the intermediate attachment unit 16 or the observation tube mounting portion 1a of the main body 1. Thereby, the imaging unit 211 is attached to the intermediate attachment unit 16 or the main body 1. In FIGS. 8 and 9, the main body mounting portion 213 of the imaging unit 211 is mounted onto the observation tube mounting portion 16b of the intermediate attachment unit 16. Moreover, the imaging unit 211 includes an imaging apparatus mounting portion 214. An imaging apparatus 215 such as the CCD camera (digital camera), TV camera, and photographing apparatus (silver salt camera) is mounted on the imaging apparatus mounting portion 214.

Inside the imaging unit 211, an image forming optical system 212 is disposed on the observation light path 18 introduced from the side of the intermediate attachment unit 16. The image forming optical system 212 forms the afocal light flux into the image on the image forming surface of the imaging apparatus 215.

According to the fifth embodiment, when the intermediate attachment unit 16 is inserted between the main body 1 and the imaging unit 211, two imaging light paths (18, 19) can easily be formed. Additionally, the intermediate attachment unit 16 is separate from the imaging unit 211. Therefore, when the intermediate attachment unit 16 is simply attached/detached, the imaging light path 19 can easily be inserted/removed without replacing the whole imaging unit 211.

According to the present invention, when the intermediate attachment unit is inserted between the microscope main body and the observation tube, the imaging light path can easily be formed. Additionally, the intermediate attachment unit is configured separately from the observation tube. Therefore, when the intermediate attachment unit is simply attached/detached, the imaging light path can easily be inserted/removed without replacing the whole observation tube.

Moreover, according to the present invention, since the image forming optical system disposed on the imaging light path can be varied in magnification, the magnification can optionally be varied on the imaging light path, and different magnifications can be set in the imaging light path and observation light path.

Furthermore, according to the present invention, when the intermediate attachment unit is simply inserted between the main body and the observation tube, the photography by the 35 mm camera and large-sized camera can easily be performed.

As described above, according to the present invention, there can be provided an inverted microscope in which the intermediate attachment unit is simply inserted/removed between the main body and the observation tube, and thereby the imaging light path can easily be inserted/removed without upgrading the observation tube.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An inverted microscope comprising:
a microscope main body including a relay optical system which forms a primary intermediate image of a sample by a light from the sample irradiated with an irradiation light via an objective lens and an image forming lens, and which relays a light flux from said primary intermediate image; and
a light path switch unit which is disposed in said microscope main body to be attachable/detachable, and which branches the light flux relayed by said relay optical system.

2. The inverted microscope according to claim 1, wherein said microscope main body has a reflective optical system which reflects the image forming light flux emitted from said image forming lens upwards by 45°.

3. The inverted microscope according to claim 1, further comprising: an observation tube including an observation-side image forming optical system which forms the light flux relayed by said relay optical system as an observation image of said sample.

4. The inverted microscope according to claim 3, wherein said light path switch unit includes a light path split member which splits the light flux relayed by said relay optical system, and is disposed between said microscope main body and said observation tube to be attachable/detachable.

5. The inverted microscope according to claim 4, wherein said light path split member splits the light flux relayed by said relay optical system to an observation light path which guides the light flux into said observation-side image forming optical system and an imaging light path which guides the light flux into a predetermined imaging apparatus.

6. The inverted microscope according to claim 5, wherein said light path switch unit includes an imaging-side image forming optical system which forms the light flux split into said imaging light path by said light path split member into an image in said imaging apparatus.

7. The inverted microscope according to claim 6, wherein said imaging-side image forming optical system has a magnification varying function.

8. The inverted microscope according to claim 6, wherein said light path switch unit includes an optical system onto which at least one of a 35 mm sized camera and a large-sized camera can be mounted, and in which the light flux of said imaging light path split by said light path split member is photographed by at least one of said 35 mm sized camera and said large-sized camera.

9. The inverted microscope according to claim 4, wherein said light path split member includes:
a first light path branch element which branches the light flux relayed by said relay optical system to the observation light path to guide the light flux into said observation-side image forming optical system and a first imaging light path;
a second light path branch element which branches said light flux into said observation light path and a second imaging light path; and
a switch mechanism which selectively switches said first light path branch element and said second light path branch element onto said light flux.

10. The inverted microscope according to claim 1, wherein said light path switch unit includes a light path split member which splits the light flux relayed by said relay optical system, and is disposed between said microscope main body and a predetermined imaging apparatus to be attachable/detachable.

11. An inverted microscope comprising:
a microscope main body including a relay optical system which irradiates a sample with an irradiation light via an objective lens, forms a light from said sample as a primary intermediate image of said sample via said objective lens and an image forming lens, and relays a light flux from said primary intermediate image;
a observation tube including an observation-side image forming optical system which forms the light flux relayed by said relay optical system as an observation image of said sample; and
an intermediate attachment unit which is disposed between said microscope main body and said observation tube to be attachable/detachable, and which includes a light path split member to split the light flux relayed by said relay optical system to an observation light path to guide the light flux into said observation-side image forming optical system and an imaging light path to guide the light flux into a predetermined imaging apparatus.

12. The inverted microscope according to claim 11, wherein said microscope main body has a reflective optical system which reflects the image forming light flux emitted from said image forming lens upwards by substantially 45°.

13. The inverted microscope according to claim 11, wherein said intermediate attachment unit includes an imaging-side image forming optical system which forms a light flux split to said imaging light path by said light path split member into an image in said imaging apparatus.

14. The inverted microscope according to claim 13, wherein said imaging-side image forming optical system has a magnification varying function.

15. The inverted microscope according to claim 11, wherein said intermediate attachment unit includes an optical system onto which at least one of a 35 mm sized camera and a large-sized camera can be mounted, and in which the light flux of said imaging light path split by said light path split member is photographed by at least one of said 35 mm sized camera and said large-sized camera.

16. The inverted microscope according to claim 11, wherein said light path split member includes:
a first light path branch element which branches the light flux relayed by said relay optical system to the observation light path to guide the light flux into said observation-side image forming optical system and a first imaging light path;
a second light path branch element which branches said light flux to said observation light path and a second imaging light path; and
a switch mechanism which selectively switches said first light path branch element and said second light path branch element onto said light flux.

17. The inverted microscope according to claim 11, wherein said intermediate attachment unit includes a light path split member which splits the light flux relayed by said relay optical system, and is disposed between said microscope main body and a predetermined imaging apparatus to be attachable/detachable.
